(19) United States
(12) Patent Application Publication
(10) Pub. No.: US 2013/0209623 A1
(43) Pub. Date: Aug. 15, 2013

(54) SACHET FOR FRUIT AND METHOD FOR PREPARING FRUIT CUT INTO PIECES IN ORDER TO PRESERVE IT IN THE MEDIUM TERM

(71) Applicant: Laurent Beaumont, Regneville Sur Mer (FR)

(72) Inventor: Laurent Beaumont, Regneville Sur Mer (FR)

(21) Appl. No.: 13/641,158

(22) PCT Filed: Apr. 4, 2011
(86) PCT No.: PCT/FR2011/050752

§ 371 Date: Apr. 26, 2013

(30) Foreign Application Priority Data
Apr. 16, 2010 (FR) 1052905
Mar. 31, 2011 (FR) 1152669

(51) Int. Cl. A23B 7/015; B65B 55/16; B65B 25/04

(52) U.S. Cl. CPC A23B 7/015; B65B 25/04; B65B 55/16
USPC 426/123; 426/234; 426/106

(57) ABSTRACT

A sachet for pieces of fruit is in the form of a tubular sachet made of transparent plastic suitable for food, which has, when empty and laid flat, a rectangular shape and in which pieces of dried fruit (MF) are collected, not under vacuum. The sealed sachet, filled with pieces of fruit, is subjected to a brief microwave treatment in order to block the development of microbes and to inhibit enzymes.

### CROSS-REFERENCE TO RELATED APPLICATION

This application is a U.S. National Phase Patent Application based on International Application No. PCT/FR2011/050752 filed Apr. 4, 2011, which claims priority to French Patent Application No. 1052905 filed Apr. 16, 2010 and French Patent Application No. 1152669 filed Mar. 31, 2011, the entire disclosures of which are hereby explicitly incorporated by reference herein.

### BACKGROUND OF THE INVENTION

1. Field of the Invention

The present invention relates to a sachet of peeled fruit and a method of preparation of sachets of fresh fruit.

2. Description of the Related Art

Peeled fruit is distributed in various ways.

For public health reasons, consumers are increasingly being encouraged to eat fruit, preferably peeled fruit. These exhortations are not, however, providing the expected results for a whole range of reasons connected with the preparation of most fruit which can only really take place in the kitchen or with the time of consumption (morning, dessert, breakfast, snack, aperitif, alone, with the family, among friends, etc.).

Lastly, the presentation of fruit or pieces of fruit continues to be a problem.

Peeled fruit tries to go some way towards resolving this problem. Attempts have been made to create new outlets by presenting peeled fruit in different ways, for instance fruit skewers, but a drawback of the fresh fruit on sale in shops, whatever the type of shop, is its very short shelf life which entails complex problems from the point of view of stock management, transport and disposal of unsold items.

Alongside fresh fruit, conserves and deep-frozen products or even processed products such as compotes are the main ways in which fruit is consumed.

Current conservation methods in particular include processes to pasteurize fruit in acidified and sugared juices. However, fruit processed in this way no longer tastes like fresh fruit. That is true of conserved fruit and fruit in plastic packaging.

Peeled fruit which is ready for use is available largely in supermarkets, chiefly in foil-covered trays or film-wrapped trays. The fruit is then in the form of a semi-conserve with a shelf life of approximately two months or in the form of peeled fruit with a conserving agent with a shelf life of approximately 12 days.

Peeled fruit without juice is also to be found but has a shorter shelf life of approximately six to seven days.

These various considerations explain why ready-to-eat fruit has not really been developed, together with factors such as a supply of products which are not defined by weight, piece size, combinations of products and the short shelf life of products which is at most four to five days in a shop with the result that such products are limited to shops of the supermarket type. Losses connected with this very short shelf life mean that supplies have to be managed in a rigorous and complex way.

The organoleptic properties of the products on offer are not the best as the products must be ripe for these properties to be fully developed and, at such a stage, they do not keep for very long.

Lastly, as a result of all these problems, the retail price of these products is relatively high.

Attempts at pasteurization by microwave technology have failed because the response of the pieces of fruit is too heterogeneous and does not guarantee the sterilization of the processed products.

### SUMMARY OF THE INVENTION

The object of the present invention is to develop a method for the preparation and distribution of ready-to-eat fruit, increasing its shelf life, while maintaining its organoleptic properties and in particular enabling the portions of fruit to be eaten without having to peel and prepare them for consumption in conditions similar to those in which confectionery is consumed.

For that purpose, the invention relates to a sachet for pieces of fruit and a method for preparing fruit cut into pieces and ready for consumption.

According to the invention, the sachet is a tubular sachet of transparent food-grade plastics material which is, when empty and flat, of rectangular shape and in which the pieces of fruit are arranged without juice and not under vacuum, the sealed sachet, filled with pieces of fruit, having undergone a brief microwave treatment in order to prevent microbial development and inhibit enzymes.

The method of preparation of the fruit cut into pieces in a sachet is characterized in that:
the cleaned fresh fruit is cut into regular pieces;
a tubular sachet having a section corresponding to that of the regular pieces of fruit is made from an airtight and steamproof food-grade plastics material which can be subject to microwave treatment;
the peeled regular pieces of fruit are disposed without liquid in a regular arrangement in the tubular sachet which is hermetically sealed;
the sealed tubular sachet is subjected to a brief microwave treatment sufficient to prevent microbial development and inhibit enzymes;
the sachet is cooled for cold storage and transport.

The term pieces of fruit denotes pieces of fruit of the same type or of the same fruit or a mixture of pieces of different fruit.

The fruit is packaged in a particularly advantageous manner in portions, for instance individual portions, in a pouch taking the form of a fully or partially transparent tubular sachet of food-grade plastics material which is airtight and steamproof.

The tubular shape of the sachet makes it possible to stack the pieces inside the sachet while limiting any overlap between them with the result that the reception of the electromagnetic energy in the microwave oven is much more homogeneous and leads to an excellent homogeneity of temperature during the microwave treatment.

According to a further feature of the method, on output from the brief microwave heat treatment, the emission of infrared rays by the pieces of treated fruit via the wall of the sachet is detected in order to ascertain that the required temperature has been properly reached in the oven for each of the pieces and, if not, the sachet is discarded as defective.

This check makes it possible to ensure that all the pieces have been properly treated to ensure their conservation in the conditions for which the invention provides.

Detection takes place by means of an infrared sensor (infrared thermometer) which, from the radiation emitted by each of the pieces of fruit, converts the radiation signal into a temperature value which is compared with a threshold to check that the required temperature has been reached.

This temperature threshold may be a temperature range within which the treatment temperature of the piece of fruit must be located. It may also be a minimum temperature or a maximum temperature.

These different temperature ranges or temperature thresholds depend on the nature of the fruit and are determined by tests.

The sachet, made for instance from polypropylene, has the advantage that it is shiny thereby highlighting the products that it contains.

The packaging which is rigid as a result of its structure and the pieces of fruit that it contains, means that the peeled fruit can be eaten without soiling one's hands while holding the sachet in only one hand. The sachet is easy to open and does not require any utensil (knife, scissors or the like) as a result of the tear notch which locally weakens the seal from the outside. After use, the packaging may be rolled up to enclose any remaining fruit or juices without polluting the environment.

According to an advantageous feature, the sachet is made from at least one sheet of plastics material folded and sealed along a longitudinal edge with a base formed by a transverse seal, the sachet being sealed after filling by another transverse seal.

According to a further variant, the sachet is made from two superimposed sheets whose longitudinal edges are sealed, the base being formed by a transverse seal and the sealed closure being provided by a transverse seal.

According to a further advantageous feature, the sachet is provided with printing and decorations on its surfaces, leaving a transparent window through which the products highlighted by the decoration of the sachet can be seen.

The method of the invention makes it possible to package peeled fruit cut into pieces which are ready to eat and may be conserved for three weeks without any substantial loss of organoleptic properties and the sachet may be left for several hours at ambient temperature before its consumption.

Advantageously, the free volume of the sachet around the pieces of fruit may be reduced before it is hermetically sealed and prior to the heat treatment so as to absorb the increase in the volume of the gases during the abrupt temperature increase generated by the heat treatment. The packaging or the sachet may thus withstand this abrupt increase in volume without requiring complex additional means such as valves which would also alter the appearance of the sachet.

It is also advantageous for practical reasons for at least one of the longitudinal seals to be weakened by a tear notch in the vicinity of the sachet's closing seal so that the sachet can be torn at this location and opened.

In a particularly advantageous manner, the method is characterized in that:
the pieces of fruit are packaged in tubular sachets of a volume much greater than the volume of the pieces of fruit to be packaged;
the sachet is sealed after substantially decreasing the free internal volume of the sachet;
the sachet is subject to a rapid microwave heat treatment in order to prevent microbial development and inhibit enzymes;
the sachet is cooled;
the pieces of fruit are grouped in a portion of the sachet without opening it;
the sachet is sealed by an intermediate seal above the portion of the sachet containing the pieces of fruit, without opening it.

The portion of the sachet above the intermediate seal which does not contain pieces of fruit is in particular cut away. The pieces of fruit in the other portion of the sachet adjoin one another thereby presenting the product obtained in a good way and encouraging direct consumption without having to touch the pieces of fruit. Moreover, as the pieces of fruit are not bathed in juice they resemble pieces of fresh fruit and retain their organoleptic properties.

According to an advantageous method, the acidity of the pieces of fruit is determined and if the pH is greater than 4.5, the pieces of fruit are acidified by immersing them in a food acid and then draining them.

In one form thereof, the present invention provides a method for the preparation of fruit cut into pieces and ready to eat, characterized in that the cleaned fresh fruit is cut into regular pieces, a tubular sachet of section corresponding to the section of the regular pieces of fruit is made from food-grade plastics material which is airtight and steamproof and can be subject to microwave treatment, the regular pieces of fruit are disposed without further liquid in a regular arrangement in the tubular sachet which is hermetically sealed, the sealed tubular sachet is subject to a brief microwave heat treatment sufficient to prevent microbial development and inhibit enzymes, and the sachet is cooled for cold storage and transport.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a plan view of a tubular sachet of the invention;

FIG. 2A is a diagrammatic section through two sheets designed to be assembled to form a sachet;

FIG. 2B shows the sachet formed by the longitudinal seals of the two sheets of FIG. 2A in cross-section;

FIG. 3A shows a strip of material folded into a U to form a sachet;

FIG. 3B shows the assembly by sealing of the two edges of the folded strip of FIG. 3A;

FIG. 3C shows a variant of the sachet of FIG. 3B with a second longitudinal seal covering the fold;

FIG. 4 is a block diagram of the method of preparation of the invention;

FIG. 5 is a block diagram of a variant of the method of preparation of FIG. 4; and

FIGS. 6A, 6B, 6C and 6D show the progress of a tubular packaging for peeled pieces of fruit during the method of the invention.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

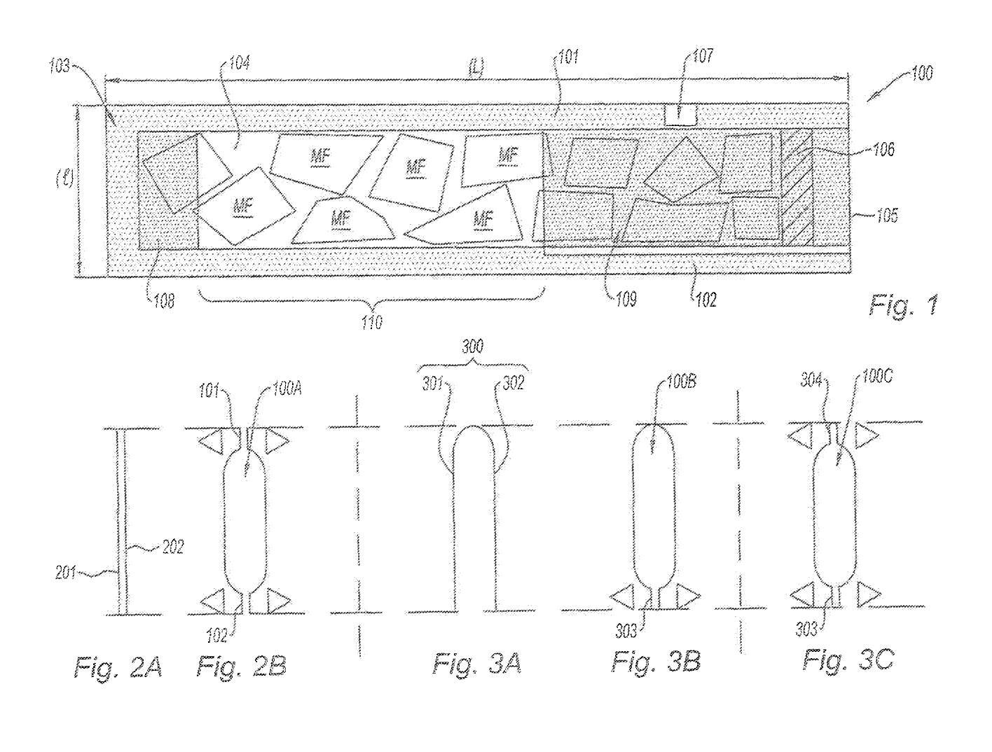

FIG. 1 shows a packaging for pieces of fruit of the invention. It is formed by a sachet 100 of a food-grade plastics material of tubular shape, i.e. whose length (L) is relatively substantial with respect to its width (l). The section is chosen as a function of the size of the pieces of fruit (MF) so that the latter, when cut, are regularly distributed in the sachet in the form of a stack. The sachet has some longitudinal rigidity as a result of its material and structure. Seen from the top, the sachet in practice has a rectangular shape bordered on each side by a wide seal 101, 102 and a base 103 which is also sealed. The fourth seal 106 provided after filling is wide such that the longitudinal seals 101, 102 and their cooperation with the transverse seals 103, 106 at their ends provide the sachet with a degree of rigidity which is increased after it has been filled with the pieces of fruit (MF).

To facilitate opening 101, at least one of the two longitudinal seals is weakened locally by a tear notch 107 so that it is possible to start to open the sachet below the transverse seal 106 closing the opening 105 of the sachet above the pieces of fruit. The sachet 100 may therefore be held in practice as a stick.

After the sachet has been closed, the pieces of fruit (MF) contained in the volume 104 of the sachet 100 are treated in a microwave oven for a short period.

The sachet 100 may comprise a decorative covering with a decorated/printed back and with decorated/printed areas on its front surface forming surfaces 108, 109 which are more or less opaque with a window 110 showing the content and highlighting it.

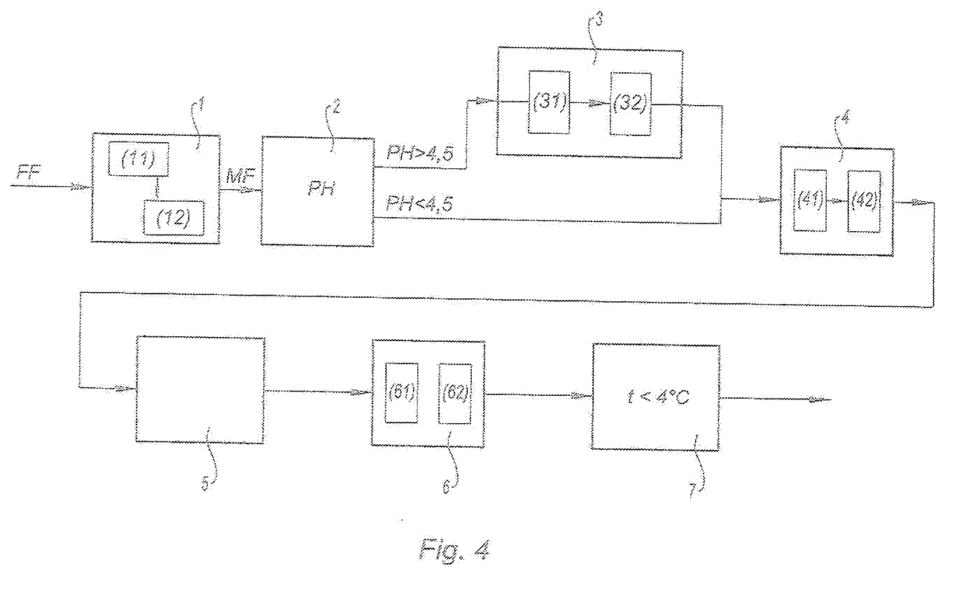

Various embodiments of a sachet 100A, 100B, 100C are shown diagrammatically in section in FIGS. 2A, 2B and 3A, 3B, 3C.

While in the first embodiment (FIGS. 2A, 2B) the sachet 100A is obtained by assembling two longitudinally sealed sheets or strips 201, 202, in the second embodiment the sachet 100B is obtained from a strip 300 of double width, folded into a U and sealed longitudinally by a seal 303 at the location of the two edges of the folded portions 301, 302 of the this U-shaped section. According to a further variant (FIGS. 3A, 3B) the sachet 100C formed from a strip folded into a U shape is nevertheless sealed both along its two edges and along the fold 304 (FIG. 3C) in order to make its structure more rigid by means of two longitudinal and parallel seals.

In general, the packaging sachets 100, 100A, 100B, 100C are tubular with a flattened section for product treatment and presentation reasons and because of the methods of consumption that they may suggest and the volume of air which necessarily remains around the pieces of fruit (MF) depending on their shape or fragility or any other packaging reason. For the brief microwave treatment, it is important for the pieces of fruit to be distributed as regularly as possible. The tubular presentation of the sachets and their content facilitates consumption in the same way as confectionery without requiring a plate or cutlery and as the pieces are not bathed in juices there is no risk of staining The maximum volume of the sachet is chosen so as to be able to absorb the air expansion in the microwave oven; where appropriate, the final volume of the sachet is reduced when treatment is complete by means of an intermediate seal so that the pieces of fruit can be grouped in a portion of the sachet in order to ensure that they remain stable, retain their presentation qualities and appropriate arrangement for consumption and are stable for the purposes of grouping and packaging of the sachets for transport and sale.

The sachet material is fully transparent or as a variant has a window 110 through which a portion of the products can be seen. The material used for the sachets 100, 100A, 100B, 100C is for instance polypropylene which has the advantage of appearing shiny, highlighting the products and satisfying the conditions required for food packaging products. The material may also be a fully or partially transparent food complex.

The sachets are filled with weighed batches of pieces of fruit so that each sachet contains a substantially identical quantity.

By way of example, the sachet has a length of 180 to 230 mm and a width when flat of 50 to 60 mm. The seals preferably have a width of 8 to 10 mm. The material used for the sachet is polypropylene of a thickness of 50μ. The filling of pieces of fruit weighs approximately 80 g.

The method of packaging fruit of the invention makes it possible to reduce the mass of waste produced to a minimum as the fruit are in practice consumed without waste leaving only the empty sachet whose material weighs approximately 1 to 2 g for a mass of fruit weighing 80 g.

FIG. 4 shows the various stages of the method of the invention for the packaging of pieces of fruit MF for consumption in portions without having to peel or prepare the fruit.

The method comprises various stages performed automatically by a plant, not described in further detail, receiving packaging information in respect of fruit, such as the type of fruit, the quantity packaged, the weight and other parameters needed for the microwave heat treatment.

The method may also be carried out in a semi-automated manner with some operations being carried out manually and others automatically.

An example of the method can be broken down into a plurality of stages:

### Stage 1: Preparation of the Fruit (1)

At the preparation stage (1), the fresh fruit FF is cleaned (11), i.e. it is peeled, washed and then cut into regular pieces (12) of a size and shape determined by the type of fruit.

### Stage 2: Acidity Check (2)

The fruit cut into pieces is subject to an acidity check (2) during which the acidity of the fruit prepared as above is determined. This measurement takes place continuously on sample pieces selected at random and at a frequency that depends on the nature of the fruit or batches of fruit. On output from the acidity check (2), the pieces of fruit are forwarded for an acid treatment stage (3) or directly to the packaging stage (4).

### Stage 3: Acid Treatment (3)

Pieces of fruit whose acidity is too low (pH of more than 4.5) are subject to an acid treatment. For that purpose, in a first stage (31), they are immersed in a bath of food acid, preferably a solution of citric or ascorbic acid, and left to soak for a short period, for instance of approximately 10 minutes. Then, in the following stage (32), the pieces of fruit are removed from the bath and left to drain.

### Stage 4: Packaging (4)

If the acidity check (2) shows that the acidity of the fruit is sufficient, i.e. that their pH is below 4.5, they are not subject to an acid treatment (3) and are directly packaged.

The pieces of fruit arriving directly or drained following the acid treatment are grouped into weighed batches to be packaged in the tubular sachets; the pieces of fruit are more or less aligned in this way in the tubular portion. The packaging takes place by dry bagging (41) without the addition of any liquid to the sachets of food-grade plastics material which are airtight and steamproof. The sachet material must enable a brief treatment in a microwave oven, i.e. the material must not release any solvent or plastics component.

According to an advantageous feature for the conduct of the heat treatment and the presentation of the bagged pieces of fruit, the maximum volume of the sachet is important with respect to the volume of the pieces of fruit.

Before the sachet is sealed, the volume of air in the sachet is reduced (41) to a minimum without crushing or compressing the pieces of fruit and the tube is then sealed. This reduction of volume may take place by aspiration without, however, creating a vacuum in the sachet.

The maximum volume of the tubular sachet is defined as a function of the volume of air remaining around the pieces of fruit.

### Stage 5: Conservation Treatment (5)

After they have been placed in the sachets, the bagged products are subject to a conservation treatment (5). The sachets are exposed to microwave radiation, rapidly applying a brief temperature increase. This heat treatment (5) is similar to pasteurization, but is carried out dry for a period of approximately 20 to 40 seconds. The parameters of the brief heat treatment depend on the nature of the fruit and the packaging mass. These parameters are determined by tests. The purpose of the heat treatment is to prevent any microbial development and inhibit enzymes in the fruit so that it retains all its qualities, and in particular its organoleptic properties. The temperature increase substantially expands the air trapped in the sealed sachet with the pieces of fruit and this abrupt increase in volume is absorbed by the maximum volume of the sachet.

### Stage 6: Completion of Packaging (6)

After the conservation treatment stage (5), the sachet is left to cool (61) and after the volume of trapped air has decreased and returned to a normal volume at ambient temperature, the dimensions of the sachet may be reduced (62) by providing a further seal or intermediate seal without opening the sachet. The excess portion of the sachet may then be removed.

### Stage 7: Storage

After cooling (6), the sachets are stored and transported to points of sale at a temperature lower than or equal to 3-4° C. After purchase, the cold chain may be interrupted for several hours before the products are consumed with no detrimental effect on the nutritional quality of the products or their organoleptic properties.

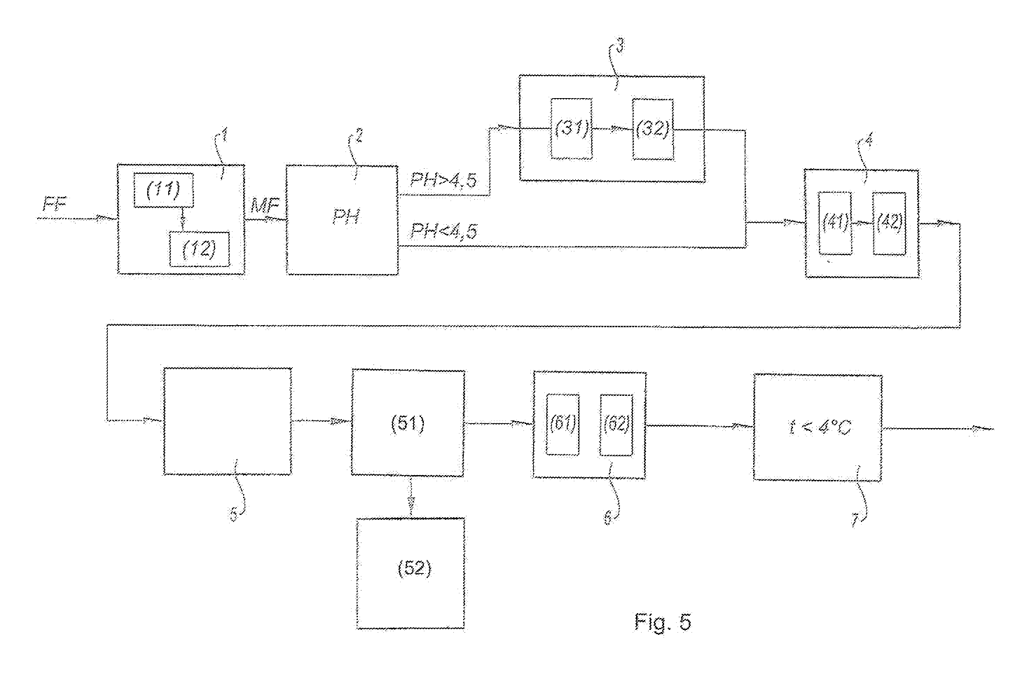

According to a variant of the process shown in FIG. 5, the conservation treatment 5 is followed by a temperature check 51. This check is carried out by means of an infrared thermometer which detects the infrared radiation emitted by the pieces of fruit contained in the sachet being output from the microwave oven 5. The check takes place piece by piece, the sachet being transferred aligned and the pieces of fruit being aligned in the sachet. This check takes place through the transparent wall of the sachet.

To enable this check, the sachet is transparent at least over the length occupied by the pieces of fruit. The whole surface of the sachet may be transparent; for instance, the back of the sachet is transparent and the front is covered with printing, decoration, etc. The transparency may be limited to a longitudinal strip on the sachet so that all the aligned pieces of fruit may be detected by the infrared thermometer (infrared sensor).

The signal from the sensor is compared with a threshold to verify that each piece of fruit in the sachet has been brought to the correct temperature (or to a temperature within a required temperature range or higher or lower than a threshold).

If one of the pieces of fruit in the sachet has not been subject to the required temperature increase, the sachet is deemed to be defective and is then discarded (52).

Stages 1 to 4 and 6 and 7 of the method described above are the same in the present variant. These stages will not therefore be described again.

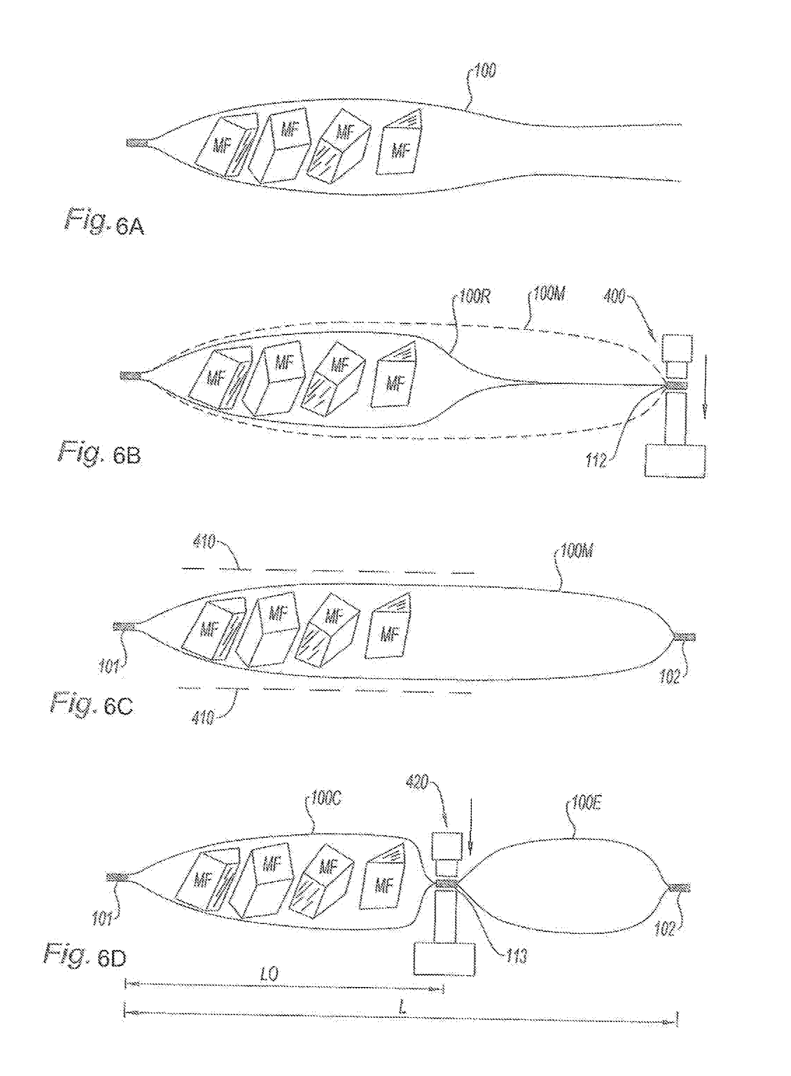

According to a further variant of the method already described above and shown in FIGS. 6A-6D, the weighed batches of pieces of fruit (MF) are packaged (FIG. 6A) after they have been drained or directly on output from the acidity check (2) in tubular sachets 100 whose length (and volume) are substantially larger than needed to package the pieces of fruit MF, even when the latter are stacked. The length L is, for instance, selected in practice to be double that needed for the pieces of fruit.

In the following stage (FIG. 6B), the sachet is partially emptied of air then sealed. The sachet has a reduced volume 100R with respect to its maximum volume 100M shown in continuous lines. Its end 112 is heat-sealed with a heat-sealing device 400.

The sealed sachet 100R is subject to a conserving heat treatment in a microwave oven 410 shown diagrammatically by two lines. The volume of air and any very small emissions of steam by the pieces of fruit MF expand and the sachet reaches its maximum volume 100M (FIG. 6C).

During the following stage (FIG. 6D), after cooling, the pieces of fruit MF are grouped on a fraction L0 of the length L of the sachet, for instance half, and this portion 100B of the sachet is sealed with respect to the remaining portion 100C by means of a heat-sealing device 420 providing an intermediate seal 113 between the ends 101, 112 of the initial sachet. At the same time as sealing is carried out, the sachet is cut to the side or in the centre of the seal 113 so that the superfluous portion 100E can be removed. The operations to group the pieces of fruit in the portion of the sachet 100C, to provide the intermediate seal 103 and to cut the surplus portion of the sachet 100E are carried out without opening the sachet cooled after its treatment in the microwave oven 410.

By way of practical example, the brief heat treatment applied to the fruit for the purposes of its packaging has a minimum or a maximum temperature. For the treatment to be effective, a minimum temperature which varies depending on the initial microbial load must be reached. In the case of a piece of pineapple or coconut, for instance, the requirements will be stricter than for a piece of melon.

In the case of the maximum temperature, account must be taken of the strength of the fruit's texture.

Thus, pineapple will withstand a temperature of 100° C., while the temperature of melon should not exceed 70° C.

The outcome of the brief heating may vary in significance. There will no change in the taste of a mango up to 90° C., whereas a kiwi should not exceed a temperature of 60° C. In general, the pieces of fruit should be treated in a temperature range which varies depending on the fruit. In the case of a piece of pineapple, the treatment should for instance be for a duration of 5 seconds at a temperature of between 80° and 100° C. In the case of a piece of mango, the treatment should be for a duration of 5 seconds at a temperature of between 70° and 90° C. In the case of a piece of melon, the treatment should be for 30 seconds at a temperature of between 50° and 70° C.

The check carried out according to the method of the invention, is a measurement of the surface temperature of each piece. This measurement takes place as mentioned above through the transparent packaging and is carried out immediately after the treatment in the oven.

It is important for the pieces of fruit to be aligned or in the form of a single layer in the packaging during treatment in the oven. After the treatment and temperature detection, when the volume of the sachet is reduced, the fruit may be otherwise arranged and may overlap.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF MAIN COMPONENTS

1 Stage 1: preparation of the fruit
   11 Cleaning of the fruit
   12 Cutting into regular pieces
2 Stage 2: acidity check
3 Stage 3: acid treatment
   31 Immersion of the pieces in a bath of food acid
   32 Draining of the pieces on output from the bath
4 Stage 4: packaging
   41 Dry bagging
   42 Reduction of the volume of air in the sachet
5 Stage 5: conservation treatment
   51 Temperature check
   52 Discarding of defective sachets
6 Stage 6: completion of packaging
   61 Cooling of the sachet
   62 Reduction of the dimensions of the sachet
7 Stage 7: storage
100, 100A, B, C Sachet
100R Sachet of reduced volume
100M Sachet of maximum volume
100C Sachet portion
100E Sachet portion
101 Sealed longitudinal edge/end
102 Sealed longitudinal edge/end
103 Transverse seal forming the base
104 Sachet volume
105 Sachet opening
106 Seal for the filled sachet
107 Tear notch
108 Opaque surface (printing/decoration)
109 Opaque surface (printing/decoration)
110 Window
112 Sealed end
113 Intermediate seal
201 First sheet forming a sachet
202 Second sheet forming a sachet
203 Longitudinal seal of the two sheets
204 Longitudinal seal of the two sheets
300 Strip
201 Folded portion of a strip
302 Further folded portion of a strip
303 Longitudinal sealing of the two strips to form the sachet 300
304 Sealing of the sachet fold
400 Heat-sealing device
410 Microwave oven
420 Heat-sealing device
MF Pieces of fruit

1-10. (canceled)

11. A method for the preparation of fruit cut into pieces and ready to eat, characterized in that:
the cleaned fresh fruit is cut into regular pieces,
a tubular sachet of section corresponding to the section of the regular pieces of fruit is made from food-grade plastics material which is airtight and steamproof and can be subject to microwave treatment,
the regular pieces of fruit are disposed without further liquid in a regular arrangement in the tubular sachet which is hermetically sealed,
the sealed tubular sachet is subject to a brief microwave heat treatment sufficient to prevent microbial development and inhibit enzymes,
the sachet is cooled for cold storage and transport.

12. A method according to claim 11, characterized in that the acidity of the pieces of fruit is determined and if the pH is greater than 4.5, the pieces of fruit are acidified by immersing them in a food acid and then draining them before placing them in the tubular sachet.

13. A method according to claim 12, characterized in that:
the pieces of fruit are packaged in tubular sachets of a much greater volume than the volume of the pieces of fruit to be packaged,
the sachet is sealed after substantially reducing the free internal volume of the sachet,
the sachet is subject to a brief microwave heat treatment in order to prevent microbial development and inhibit enzymes,
the sachet is cooled,
the pieces of fruit are grouped in a portion of the sachet without opening it,
the sachet is sealed by an intermediate seal above the portion of the sachet containing the pieces of fruit, without opening it.

14. A method according to claim 13, characterized in that the portion of the sachet above the intermediate seal and not containing pieces of fruit is cut away in order to obtain the sachet of pieces of fruit ready for sale.

15. A method according to claim 13, characterized in that on output from the brief microwave heat treatment, the emission of infrared radiation from the pieces of fruit treated in the sachet is detected in order to check that the required temperature has been reached in the oven and, if not, the sachet is discarded as defective.

16. A sachet for pieces of fruit resulting from the method of preparation according to claim 11, characterized in that it has the form of a tubular sachet of transparent food-grade plastics material having, when empty and flat, a rectangular shape in which pieces of fruit (MF) are grouped without juice and not under vacuum, the sealed sachet filled with pieces of fruit having been subject to a brief microwave treatment to prevent any microbial development and inhibit enzymes.

17. A sachet for pieces of fruit according to claim 16, characterized in that it is made from at least one sheet of plastics material folded and sealed along a longitudinal edge and has a base formed by a transverse seal, the sachet being sealed after filling by a further transverse seal.

18. A sachet for pieces of fruit according to claim 11, characterized in that it is made from two superimposed sheets whose longitudinal edges are sealed, the base being formed by a transverse seal and the sealed closure being formed by a further transverse seal.

19. A sachet for pieces of fruit according to claim 16, characterized in that it comprises surfaces for printing and decoration on its various surfaces, leaving a transparent portion through which at least part of the pieces of fruit packaged in the sachet can be seen.

20. A sachet for pieces of fruit according to claim 16, characterized in that at least one of the longitudinal seals is weakened by a tear notch in the vicinity of the closure of the sachet so that the sachet can be torn at that location and opened.
